(19) United States
(12) Patent Application Publication
(10) Pub. No.: US 2002/0040122 A1
(43) Pub. Date: Apr. 4, 2002

(54) Water blown rigid polyurethane foam with improved fire retardancy

(76) Inventors: Sol M. Mirasol, Woodstock, GA (US); Stephen J. Williams, Friendswood, TX (US); Debkumar Bhattacharjee, Lake Jackson, TX (US)

Correspondence Address: THE DOW CHEMICAL COMPANY, INTELLECTUAL PROPERTY SECTION, 2301 N BRAZOSPORT BLVD, FREEPORT, TX, 77541-3257, US

(21) Appl. No.: 09/879,253

(22) Filed: Jun. 12, 2001

Related U.S. Application Data
(60) Provisional application No. 60/212,512, filed on Jun. 19, 2000.

(51) Int. Cl. C08G 18/48

(52) U.S. Cl. 528/77

(57) ABSTRACT

A rigid water blown polyurethane foam with improved and unexpected fire retardancy can be prepared from a formulation including a B component which is a mixture of a first polyol that is an ultra low viscosity Mannich polyol and a second polyol that is not. The foams of the present invention are particularly useful for spray foam, pour-in-place, and lamination applications and have properties similar to conventional foams.

### BACKGROUND OF THE INVENTION

1. Field of the Invention

The present invention relates to polyol mixtures, polymers, polymer articles, and methods of making and using said polyol mixtures, polymers and articles. In another aspect, the present invention relates to polyol mixtures comprising a Mannich polyol, polyurethanes made from such polyol mixtures, articles made from said polyurethane, and methods of making and using said polyol mixtures, polyurethanes and polyurethane articles. In even another aspect, the present invention relates to polyol mixtures comprising a ultra low viscosity Mannich polyol, polyurethanes made from such polyol mixtures, articles made from said polyurethane, and methods of making and using said polyol mixtures, polyurethanes and polyurethane articles. In still another aspect, the present invention relates to polyurethane foams, articles made from polyurethane foams, and methods of making and using said polyurethane foams and articles. In yet another aspect, the present invention relates to water blown polyurethane foams, articles made from such water blown polyurethane foams, and methods of making and using said foams and articles. In still another aspect, the present invention relates to water blown polyurethane foams, a process of preparing water blown polyurethane foams particularly in 1:1 ratio spray and generally in pour-in-place and lamination applications with unexpectedly improved fire retardancy of such foam polymer composition.

2. Description of the Related Art

It has long been known to prepare rigid polyurethane foams by the reaction of a polyisocyanate with a hydroxyl-terminated polyester or poly(oxyalkylene)ether having a hydroxyl number within the range of from 350 to 900. One group of polyols useful for preparing such foams includes the nitrogen-containing polyols described in U.S. Pat. Nos. 3,297,597, 4,137,265, and 4,383,102 ('102). The nitrogen containing polyols which are prepared by alkoxylation of the reaction product of a phenol, alkanolamines and formaldehyde, such as those disclosed in '102 above, shall be hereinafter referred to as Mannich polyols. It has been reported in the literature that polyurethane foam prepared from these polyols is characterized by a greater inherent fire retardancy and good dimensional strength when extraneous fire retardants are employed.

One area of use for such polyols has been in spray foams systems used in roof and pipe insulation applications. The equipment normally used for the industrial application of sprayed urethane foam uses “double acting” positive displacement pumps which have the advantage of supplying an accurate component ratio of polyisocyanate component to polyol component (hereinafter A-component to B-component or A:B) in a continuous stream. A major disadvantage of this metering system is that it will function reliably only if each component has a viscosity of less than 1,000 centipoise at ambient temperature. At higher viscosities, cavitation can occur resulting in a component ratio change which can affect the foam product quality. Another disadvantage is that the commercially adopted standard design for such equipment requires a volume ratio of A-component to B-component of 1.

Other areas of use of such polyols has been in pour-in-place and lamination applications of which foams are used such as in entry doors, portable coolers, garage doors, building panels, water heaters, or reefer containers for construction and insulation purposes. The types of equipment used for theses applications are the conventional variable ratios, generally A-component to B-component of 0.2 to 4.0.

Typically, in the past, the formulations used to prepare spray systems have included halocarbon blowing agents. In the present, the use of many of the traditional blowing agents have been discontinued, or phased out, because of the belief that they contribute to the destruction of the ozone layer which limits the amount of ultraviolet radiation which penetrates the atmosphere. This has resulted in a search for alternative blowing agents such as water.

While water is a useful blowing agent in many types of polyurethane foam, it does not have all of the properties of the halocarbon blowing agents which it has replaced. For example, one disadvantage of water as a blowing agent in polyol formulations including Mannich polyols is water does not reduce the viscosity of Mannich polyols as effectively as halocarbon blowing agents. As stated above, attempting to make foams with formulations which are too high in viscosity can cause problems with some kinds of foam making equipment.

However, in spite of the above advancements, there still exists a need in the art for foams, foam articles, and methods of making and use such foams and articles.

There is another need in the art for apparatus and methods for foams, foam articles, and methods of making and use such foams and articles, which do not suffer from the deficiencies of the prior art.

There is even another need in the art for water blown polyurethane foams, articles from such foams, and methods of preparing such foams from formulations including Mannich polyols to use an ultra low viscosity Mannich polyol of sufficiently low viscosity to avoid handling problems such as cavitation problems with foam forming equipment.

There is still another need in the art for water blown polyurethane foams, articles from such foams, and methods for preparing such foams from formulations where the volume ratio of A-component to B-component is about 1.

There is yet another need in the art for fire retardant water blown polyurethane foams, articles from such foams, and methods of preparing and using such foams.

These and other needs in the art will become apparent to those of skill in the art upon review of this specification, including its drawings and claims.

### SUMMARY OF THE INVENTION

It is an object of the present invention to provide for foams, foam articles, and methods of making and use such foams and articles.

It is another object of the present invention to provide for apparatus and methods for foams, foam articles, and methods of making and use such foams and articles, which do not suffer from the deficiencies of the prior art.

It is even another object of the present invention to provide for water blown polyurethane foams, articles from such foams, and methods of preparing such foams from formulations including Mannich polyols to use an ultra low viscosity Mannich polyol of sufficiently low viscosity to avoid handling problems such as cavitation problems with foam forming equipment.

It is still another object of the present invention to provide for water blown polyurethane foams, articles from such foams, and methods for preparing such foams from formulations where the volume ratio of A-component to B-component is about 1.

These and other objects will become apparent to those of skill in the art upon review of this specification, including its drawings and claims.

According to one embodiment of the present invention, there is provided a composition for preparing polyurethane. The composition includes a polyisocyanate component. The composition further includes a polyol component comprising a first polyol comprising an ultra low viscosity Mannich polyol having a viscosity less than about 3,500 cps (3.5 Pa*s) at 25° C., and a second polyol comprising a polyol that is not an ultra low viscosity Mannich polyol.

According to another embodiment of the present invention, there is provided a polyurethane that is the reaction product of a polyisocyanate component and a polyol component. The polyol component includes a first polyol comprising an ultra low viscosity Mannich polyol having a viscosity less than about 3,500 cps (3.5 Pa*s) at 25° C., and a second polyol comprising a polyol that is not an unltra low viscosity Mannich polyol.

According to even another embodiment of the present invention, there is provided a polyol composition including a first polyol comprising an ultra low viscosity Mannich polyol having a viscosity less than about 3,500 cps (3.5 Pa*s) at 25° C.; and a second polyol comprising a polyol that is not an ultra low viscosity Mannich polyol.

In preferred embodiments of the above embodiments, the second polyol comprises a Novalak polyol.

These and other embodiments will become apparent to those of skill in the art upon review of this specification, including its drawings and claims.

### DETAILED DESCRIPTION OF THE INVENTION

The composition of the present invention includes an A-component comprising polyisocyanate, and a B-component comprising a polyol. Preferably, the composition of the present invention comprises an A-component comprising polyisocyanate, and a B-component comprising two or more polyols. More preferably, the composition of the present invention comprises an A-component comprising polyisocyanate, and a B-component comprising as a first polyol a Mannich polyol and a second polyol different from the first polyol. Even more preferably, the composition of the present invention comprises an A-component comprising polyisocyanate, and a B-component comprising a first polyol comprising an ultra low viscosity Mannich polyol and a second polyol not an ultra low viscosity Mannich polyol. Still more preferably, the composition of the present invention comprises an A-component comprising polyisocyanate, and a B-component comprising a first polyol comprising ultra low viscosity Mannich polyol and a second polyol comprising a Novolac initiated polyol.

The composition of the present invention may optionally include additives to impart desired physical properties to the composition, or in the resulting articles made from such composition.

The A component and the B components of the composition of the present invention are admixed at any suitable volume or weight ratio (A:B) as desired for the particular composition, formulation method or equipment, application method or equipment, or end product.

Generally, when A:B is expressed as a volume ratio, the compositions of the present invention will have an A:B volume ratio that is in the range of about 0.2 to about 3.5, preferably in the range of about 0.6 to about 2.0, and more preferably in the range of about 0.9 to about 1.4. As a non-limiting example, the volume ratio of about 1 may be obtained for use with commercially available spray systems. Notice that while the composition of the present invention may be formulated at volume ratios other than about 1, this volume ratio of about 1 is beneficial to spray foam applications in particular as the spraying equipment commercially available at this time for applying spray foams works best at this volume ratio.

Generally, when A:B is expressed as a weight ratio, the compositions of the present invention will have an A:B weight ratio that is in the range of about 0.2 to about 4, preferably in the range of about 0.6 to about 2.5, and more preferably in the range of about 1.0 to about 1.6. As another non-limiting example, the composition of the present invention may be formulated for pour-in-place and lamination systems at a weight ratio preferably in the range of about 1 to about 3

While polyurethane foam formulations which include water as the only blowing agent are preferred embodiments of the present invention, it is contemplated that the present invention includes formulations having minor amounts of mixed blowing agents as well. For example, both water and one or more of the following materials could be used as blowing agents for the formulations of the present invention: hydrocarbons, chlorinated hydrocarbons, fluorinated hydrocarbons generally. Preferably the blowing agent used with water for formulations of the present invention is HCFC-141 b, HCFC-22, HFC-134a, n-pentane, isopentane, cyclopentane, HCFC-124, HFC-245fa and HFC-365 mfc.

Water is the preferred blowing agent for formulations of the present invention. In formulations useful for preparing the polyurethane foams of the present invention, water will be present at a concentration of from 0.5 to 25 parts per hundred parts of polyol. Preferably water is present at a concentration of from 1 to 15 parts per hundred parts of polyol. Even more preferably water is present at a concentration of from 1.5 to 10 parts per hundred parts of polyol.

The foams prepared with the compositions of the present invention have structural properties and dimensional stability similar to conventional spray foam systems produced with halocarbon blowing agents. The resulting foam polymer is characterized with improved and unexpected fire retardancy for the standard roof spray applied requirements in particular.

The B-component

Generally, the B-component comprises a first polyol comprising one or more ultra ultra low viscosity Mannich polyols and a second polyol that is not an ultra low viscosity Mannich polyol. The second polyol will comprise one or more polyols that are not ultra low viscosity Mannich polyol.

In the practice of the present invention, the B-component will generally comprise in the range of about 2 to about 90 weight percent (by volume) ultra low viscosity Mannich polyol, and in the range of about 10 to about 98 weight percent (by volume) second polyol, based on the total weight of ultra low viscosity Mannich polyol and second polyol. Preferably, the B-component will comprise in the range of about 20 to about 70 weight percent ultra low viscosity Mannich polyol, and in the range of about 30 to about 80 weight percent second polyol, and more preferably will comprise in the range of about 35 to about 45 weight percent ultra low viscosity Mannich polyol, and in the range of about 55 to about 65 weight percent second polyol, based on the total weight of ultra low viscosity Mannich polyol and second polyol.

In the method of making the B-component, the ultra low viscosity Mannich polyol and the second polyol are contacted together using any suitable method and apparatus as are known to those of skill in the art for combining polyols.

Mannich polyol

In one embodiment of the present invention, a polyurethane foam formulation B-component includes an ultra low viscosity Mannich polyol having a viscosity of from 300 to 3,500 cps (0.3 to 3.5 Pa*s) at 25 C. In the practice of the present invention, the B-component may comprise only one or even a mixture of ultra low viscosity Mannich polyols.

Examples of suitable ultra low viscosity Mannich polyols and their method of making, can be found in copending U.S. Patent Application Ser. No. 09/389,699, filed Sep. 3, 1999, and herein incorporated by reference.

The Mannich polyols useful with the present invention are prepared by admixing a phenol, an alkanolamine, and a formaldehyde mixed in molar ratios resulting in an initiator which can be alkoxylated to prepare polyols that have a nominal functionality of from 3 to 5.5. For purposes of the present invention, the nominal functionality of the Mannich polyols useful with the present invention is equal to the theoretical functionality of the initiator. For example, if unsubstituted phenol and diethanolamine are used with formaldehyde to prepare a Mannich initiator of the present invention in a molar ratio of 1:3:3, the nominal functionality of the resulting polyol is 7 because there are three sites on phenol for formaldehyde to bond and each of those sites is subject to bonding with diethanolamine which is itself di-hydroxy functional. Therefore, such a polyol is 7 functional because each of the 3 diethanolamine results in 2 OH groups and the sum of those 6 OH groups and the original phenolic OH group equals 7.

The Mannich initiators are alkoxylated using a mixture of ethylene oxide and propylene oxide. Using a mixture of ethylene oxide and propylene oxide to alkoxylate these initiators allows for the production of a Mannich polyol with comparatively very low viscosities. The ultra low viscosity Mannich polyols useful with the present invention preferably have a viscosity of from 300 to 1500 cps (0.3 to 1.5 Pa*s), and more preferably have a viscosity of from 300 to 1000 cps (0.3 to 1.0 Pa*s). Care should be used when preparing the Mannich polyol initiators to use the appropriate molar ratios of the phenols, alkanolamines, and formaldehyde to achieve the desired nominal functionality. The preferred ratio of phenol and formaldehyde for preparing the Mannich polyols useful with the present invention is from 1:1 to 1:2.2. More preferably the ratio of phenol to formaldehyde is from 1:1.5 to 1:2.

The preferred molar ratio of formaldehyde to alkanolamine for use in preparing Mannich polyols useful with the present invention is 1:1. Additional quantities of alkanolamines can be used in preparing the initiators of the present invention, but are neither required nor usually desirable. Use of additional alkanolamines promotes the formation of polyols resulting from the alkoxylation of the alkanolamine. For example, wherein the alkanolamine is diethanolamine and it is used in excess of the molar ratios specified above and not removed prior to alkoxylation, it can be alkoxylated to form a triol. The presence of such amine initiated polyols can result in lower viscosities of the resulting polyol mixtures, but can also lower average functionality which is sometimes undesirable. Use of less than a 1:1 molar ratio of alkanolamine to formaldehyde can also result in Mannich polyol initiators having lower nominal functionalities. Preferably, the Mannich polyol initiators of the present invention are prepared using a molar ratio of phenol to alkanolamine to formaldehyde of from 1:1:1 to 1:2.2:2.2, more preferably from 1:1.5:1.5 to 1:2:2, and most preferably 1:2:2.

Phenols which can be used to prepare the Mannich polyols useful with the present invention include: o-, m-, or p-cresols, ethylphenol, nonylphenol, p-phenylphenol, 2,2-bis(4-hydroxyphenol) propane, beta-naphthol, beta-hydroxyanthracene, p-chlorophenol, o-bromophenol, 2,6-dichlorophenol, p-nitrophenol, 4-nitro-6-phenylphenol, 2-nitro-4-methylphenol, 3,5-dimethylphenol, p-isopropylphenol, 2-bromo-4-cyclohexylphenol, 4-t-butylphenol, 2-methyl-4-bromophenol, 2-(2-hydroxypropyl)phenol, 2-(4-hydroxyphenol) ethanol, 2-carbethoxyphenol, 4-chloro-methylphenol and mixtures thereof. It is especially preferred that the phenols used to prepare the Mannich polyols useful with the present invention be unsubstituted phenol.

The alkanolamine to be reacted with the phenolic compound and formaldehyde in accordance with preparing the Mannich polyols useful with the present invention is an alkanolamine selected from the group consisting of mono-and di-alkanolamines and ammonia. Examples of suitable alkanolamines that may be used are monoethanolamine, diethanolamine, isopropanolamine, diisopropanolamine, bis(2-hydroxypropyl)amine, hydroxyethyl-methylamine, N-hydroxy-ethylpiperazine, N-hydroxybutylamine, N-hydroxyethyl-2,5-dimethlpiperazine, and mixtures thereof. It is especially preferred that the amine used be diethanolamine. It is also anticipated that ammonia, NH₃, could be used in the place of the alkanolamine and still be within the scope of this invention. Mixtures of alkanolamines can also be used to prepare the ultra low viscosity polyols useful with the present invention.

The Mannich polyols useful with the present invention are prepared by admixing an amine, phenol and formaldehyde under reaction conditions sufficient to prepare an active hydrogen containing material known as a Mannich initiator (or Mannich base), and then alkoxylating the Mannich initiator. Any reaction conditions sufficient to prepare the initiator and known to one of ordinary skill in the art of preparing aromatic amine polyols can be used. For example, the general process of '102 wherein: (1) first, phenol and amine and then formaldehyde are admixed; (2) and then heated at from 50 C to 150 C for a period of time sufficient to reduce the formaldehyde concentration to less than 1 weight percent; (3) and the resultant solution is stripped of water; and (4) the water stripped initiator is alkoxylated at from 30 C to 200 C, can be used with the present invention.

Water is stripped from the Mannich initiator prior to alkoxylation in preparing the Mannich polyols useful with the present invention. Preferably, water is stripped from the initiator until it is present in a range of from 0.5 to 1.5 percent by weight in the Mannich base prior to alkoxylation. Like excess alkanolamines, water too can react with alkylene oxides to form polyols except that in the case of water, the resulting polyol is a diol. The presence of too much diol in the Mannich polyols useful with the present invention can lower average functionality which is sometimes undesirable.

The Mannich polyols useful with the present invention are prepared by alkoxylating a Mannich initiator. Minor amounts of any alkylene oxide can be used to prepare the Mannich polyols useful with the present invention, but at least 50 weight percent of the alkylene oxides used are ethylene oxide and propylene oxide. Of the combined weight of ethylene oxide and propylene oxide used to prepare the Mannich polyols useful with the present invention, from 5 to 55 percent is ethylene oxide either in the form of a mixed feed or added as a block addition after completion of other alkoxylation reactions. Preferably, of the combined weight of ethylene oxide and propylene oxide used to prepare the Mannich polyols useful with the present invention, from 10 to 45, more preferable from 15 to 30, and most preferable about 20 percent of the alkylene oxide is ethylene oxide.

Besides the method of addition described above, the ultra low viscosity Mannich polyols can be prepared using any method known to be useful to those skilled in the art of preparing polyols. It is preferred, however, that the first method outlined above be used. This preferred method mixes the phenol and alkanolamine first and then adds the formaldehyde before the alkylene oxide addition. Care should be taken that phenol and formaldehyde are not admixed under conditions which could lead to the formation of undesirable byproducts, unless such a result is desired.

In preparing the Mannich polyols useful with the present invention, the minimum desirable amount of alkylene oxide used is about 0.3 moles per hydroxyl group in the Mannich base. The maximum desirable amount of alkylene oxide is about 3.5 moles per hydroxyl group. In general, phenolic hydroxyl groups form unstable urethane linkages and so are to be avoided where practical. Since phenolic hydroxyl groups are reactive, the phenolic hydroxyl groups will react with the alkylene oxide, thereby assuring reaction of the phenolic hydroxyl groups when the stoichiometric amount of alkylene oxide is used.

The ultra low viscosity Mannich polyols useful with the present invention have OH numbers (also known as hydroxyl numbers) of from about 200 to about 500. The OH number of a polyol of known equivalent weight can be calculated by dividing 56,100 by the equivalent weight of the polyol with the product being the OH number. It can be difficult to prepare Mannich polyols useful with the present invention with OH numbers of less than about 350 without using a catalyst to supplement the autocatalytic properties of the Mannich bases. Mannich Polyols having OH numbers of from 250 to 350 can be prepared using supplemental catalysts such as trimethyl amine, potassium hydroxide. When such supplemental catalysts are used, care should be taken to remove or neutralize the supplemental catalysts if the intended use of the polyol is one wherein the presence of the catalyst would be undesirable. The ultra low viscosity Mannich polyols useful with the present invention preferably have an OH number of from about 200 to about 450. Most preferably, the polyols have an OH number of from about 250 to about 400, even more preferably from about 250 to about 350, and still more preferably, from about 275 to about 325.

Conventional Mannich polyols have viscosities of greater than 3500 cps (3.5 PAs) at 25 C. For example, VORANOL 470X* has a viscosity of 7,000 to about 13,000 cps (7-13 PAs) @ 25 C. (*VORANOL 470X is a trade designation of The Dow Chemical Company). Use of conventional Mannich polyols in a water blown system can cause equipment failure and other processing difficulties. In addition, when made, foams prepared using conventional Mannich polyols and water as a blowing agent can have coarse cell structure, rough skin surface, poorer dimensional stability, poorer flame retardancy, and poorer substrate adhesion. The ultra low viscosities of the Mannich polyols useful with the present invention allow for their use with water blown systems in formulations which present minimal processing difficulties, finer foam cell structure, smoother foam skin surface, dimensionally stable foam, improved foam flame retardancy, and improved substrate foam adhesion.

Second Polyol

In addition to the ultra low viscosity Mannich polyols, the B-component of the present invention comprises a second polyol which comprises one or more polyols that are not ultra low viscosity Mannich polyols. Non-limiting examples of polyols suitable for the second polyol include Mannich polyols having a viscosity greater than 3500 cps (3.5 PAs) at 25 C, Novolac polyols, and other aromatic group containing polyols, minor amounts of other polyols and other active hydrogen containing materials can be included in formulations useful for making the foams of the present invention. Active hydrogen containing compounds most commonly used in polyurethane production are those compounds having at least two hydroxyl groups. Those compounds are referred to herein as polyols.

The selection of polyols for use in the second polyol is generally dictated by the end use of the polyurethane utimately derived therefrom.

As a non-limiting example, in certain spray applications, the second polyol may be selected based on several criteria. A first criteria, aromatic content, is selected to increase the flame retardant characteristics of the foam which will be prepared from the formulation. A second criteria is functionality per unit volume which is selected to result in a foam formulation where the volume ratio of A component to B component is about 1 for spray applications in particular and 1 to 3 for pour-in-place and lamination applications in general. A third criteria is that the viscosity of the polyol admixture is less than about 3500 cps (3.5 PAs) at 25 C. A fourth criteria is that the resulting foam is dimensionally stable, improved flame retardancy, minimal processing difficulties, improved substrate adhesion, fine cell structure, and smooth surface.

Novolac initiated polyols

Preferably, the second polyol will comprise one or more Novolac initiated polyols. Such Novolac resins are generally prepared by polymerization of phenol and formaldehyde in the presence of an acid catalyst. The Novolac polyols useful with present invention are prepared by alkoxylating a Novolac resin with one or more epoxides similar to the preparation of Mannich polyols.

In general, Novolac polyols useful in preparing the polyols of the present invention will have an aromatic content greater than about 5, a functionality of greater than about 2, and an equivalent weight greater than about 120. Preferably, Novolac polyols useful in preparing the polyols of the present invention will have an aromatic content greater than about 20, a functionality of greater than about 2.5, and an equivalent weight greater than about 200. More preferably, Novolac polyols useful in preparing the polyols of the present invention will have an aromatic content greater than about 30, a functionality of greater than about 3, and an equivalent weight greater than about 260. An illustrative non-limiting example of such a suitable Novolac polyol includes one having an OH number of about 200, prepared from Novolac initiator and having an aromatic content of about 37 percent.

In addition to Novolac polyols other polyols having similar aromatic content, functionality, and equivalent weights can be used as long as the B side prepared with them has a viscosity of less than about 3500 cps (3.5 PAs) at 25 C

Such polyols include alkoxylated (ethylene oxide and propylene oxide) Bis-phenol A based polyol and TDA based polyol with functionality greater than 3.0.

Other polyols

In addition to the ultra low viscosity Mannich polyols, Novolac polyols, and other aromatic group containing polyols, minor amounts of other polyols and other active hydrogen containing materials can be included in formulations useful for making the foams of the present invention. Active hydrogen containing compounds most commonly used in polyurethane production are those compounds having at least two hydroxyl groups. Those compounds are referred to herein as polyols. Representatives of suitable polyols are generally known and are described in such publications as High Polymers, Vol. XVI, “Polyurethanes, Chemistry and Technology” by Saunders and Frisch, Interscience Publishers, New York, Vol. 1, pp. 32-42, 44-54 (1962) and Vol. 11, pp. 5-6, 198-199 (1964); Organic Polymer Chemistry by K. J. Saunders, Chapman and Hall, London, pp. 323-325 (1973); and Developments in Polyurethanes, Vol. 1, J. M. Burst, ed., Applied Science Publishers, pp. 1-76 (1978).

However, any active hydrogen containing compound can be used with the present invention. Examples of such materials include those selected from the following classes of compositions, alone or in admixture: (a) alkylene oxide adducts of polyhydroxyalkanes; (b) alkylene oxide adducts of non-reducing sugars and sugar derivatives; (c) alkylene oxide adducts of phosphorus and polyphosphorus acids; and (d) alkylene oxide adducts of polyphenols. Polyols of these types are referred to herein as “base polyols”. Examples of alkylene oxide adducts of polyhydroxyalkanes useful herein are adducts of ethylene glycol, propylene glycol, 1,3-dihydroxypropane, 1,4-dihydroxybutane, and 1,6-dihydroxyhexane, glycerol, 1,2,4-trihydroxybutane, 1,2,6-trihydroxyhexane, 1,1,1-trimethylolethane, 1,1,1-trimethylolpropane, pentaerythritol, polycaprolactone, xylitol, arabitol, sorbitol, mannitol. Preferred herein as alkylene oxide adducts of polyhydroxyalkanes are the ethylene and propylene oxide adducts of di-and tri-hydroxyalkanes. Other useful adducts include ethylene diamine, glycerin, ammonia, 1,2,3,4-tetrahydroxy butane, fructose, and sucrose.

Polyamines, amine-terminated polyols, polymercaptans and other isocyanate-reactive compounds are also suitable in the present invention. Polyisocyanate polyaddition active hydrogen containing compounds (PIPA) can be used with the present invention. PIPA compounds are typically the reaction products of TDI and triethanolamine. A method for preparing PIPA compounds can be found in, for example, U.S. Pat. No. 4,374,209, issued to Rowlands.

Another class of polyols which can be included in minor amounts with the present invention are “copolymer polyols”, which are base polyols containing stablely dispersed polymers such as acrylonitrile-styrene copolymers. Production of these copolymer polyols can be from reaction mixtures comprising a variety of other materials, including, for example, catalysts such as azobisisobutyro-nitrile; copolymer polyol stabilizers; and chain transfer agents such as isopropanol.

Polyester polyols can also be used, preferably in minor amounts, with the present invention. For example, polyester polyols derived from phthalic anhydride (PAA), dimethylterephthalate (DMT) or the recycling of polyethylene terephthalate (PET) can be used. Conventional polyester polyols can also be used. The polyester polyol component in its broadest scope can be any polyester polyol. Preferably, the polyol has a molecular weight from 250 to 1000 and a hydroxyl functionality of from 2 to 6. Most preferably, the molecular weight falls within the range of 300 to 600 and a hydroxyl functionality of from 2 to 4.

Typical polyester polyols include, for example, reaction products of polyhydric (preferably dihydric) alcohols, optionally with the addition of trihydric alcohols, and polybasic carboxylic acids or anhydrides. Instead of free polycarboxylic acids, the corresponding polycarboxylic acid anhydrides or corresponding polycarboxylic acid esters of lower alcohols or mixtures thereof may, of course, be used for preparing the polyesters. The polycarboxylic acids may be aliphatic, cycloaliphatic, aromatic, and/or heterocyclic and they may be substituted, for example, by halogen atoms, and/or may be unsaturated. Exemplary compounds include succinic acid, adipic acid, sebacic acid, phthalic acid, isophthalic acid, trimellitic acid, phthalic acid anhydride, tetrahydrophthalic acid anhydride, hexahydrophthalic acid anhydride, tetrachlorophthalic acid anhydride, glutaric acid anhydride, maleic acid, maleic acid anhydride, dimeric and trimeric fatty acids such as oleic acid. Exemplary polyhydric alcohols include ethylene glycol, butylene glycol, hexanediol, octanediol, neopentyl glycol, cyclohexane dimethanol, 2-methyl-1,3-propanediol, glycerol, trimethylolpropane, hexanetriol, butanetriol, trimethylolethane, pentaerythritol, mannitol, sorbitol, methyl glycoside, diethylene glycol, triethylene glycol, dipropylene glycol, polypropylene glycol, dibutylene glycol, polybutylene glycols. Polyesters of lactones may also be used.

The A-component

The polyurethane foams of the present invention are prepared by admixing a polyisocyanate A-component with a B component. The polyisocyanate A-component of the formulations of the present invention include those as are well known to those of skill in the art, and it is not intended that the A-component be limited to those illustrated herein. For example, the polyisocyanate A-component of the formulations of the present invention can be advantageously selected from organic polyisocyanates, modified polyisocyanates, isocyanate-based prepolymers, and mixtures thereof. These can include aliphatic and cycloaliphatic isocyanates, but aromatic and especially multifunctional aromatic isocyanates are preferred, and polyphenyl polymethylene polyisocyanates (PMDI) is most preferred.

Other polyisocyanates useful with the present invention include 2,4- and 2,6-toluenediisocyanate and the corresponding isomeric mixtures; 4,4′-,2,4′- and 2,2′-diphenyl-methanediisocyanate and the corresponding isomeric mixtures; mixtures of 4,4′-, 2,4′- and 2,2′-diphenyl-methanediisocyanates and polyphenyl polymethylene polyisocyanates PMDI; and mixtures of PMDI and toluene diisocyanates. Also useful for preparing the polyurethanes of the present invention are aliphatic and cycloaliphatic isocyanate compounds such as 1,6-hexamethylene-diisocyanate; 1-isocyanato-3,5,5-trimethyl-1-3-isocyanatomethyl-cyclohexane; 2,4- and 2,6-hexahydrotoluene-diisocyanate, as well as the corresponding isomeric mixtures; 4,4′-, 2,2′- and 2,4′-dicyclohexylmethanediisocyanate, as well as the corresponding isomeric mixtures. 1,3 Tetramethylene xylene diisocyanate can also be used with the present invention.

Also advantageously used for the polyisocyanate component of the formulations of the present invention are the so-called modified multifunctional isocyanates, that is, products which are obtained through chemical reactions of the above diisocyanates and/or polyisocyanates. Exemplary are polyisocyanates containing esters, ureas, biurets, allophanates and preferably carbodiimides and/or uretonimines; isocyanurate and/or urethane group containing diisocyanates or polyisocyanates. Liquid polyisocyanates containing carbodiimide groups, uretonimine groups and/or isocyanurate rings, having isocyanate groups (NCO) contents of from 10 to 40 weight percent, more preferably from 20 to 35 weight percent, can also be used. These include, for example, polyisocyanates based on 4,4′-, 2,4′- and/or 2,2′-diphenylmethane diisocyanate and the corresponding isomeric mixtures, 2,4- and/or 2,6-toluenediisocyanate and the corresponding isomeric mixtures; mixtures of diphenylmethane diisocyanates and PMDI and mixtures of toluenediisocyanates and PMDI and/or diphenylmethane diisocyanates.

Suitable prepolymers for use as the polyisocyanate component of the formulations of the present invention are prepolymers having NCO contents of from 2 to 40 weight percent, more preferably from 4 to 30 weight percent. These prepolymers are prepared by reaction of the di- and/or poly-isocyanates with materials including lower molecular weight diols, triols, but also they can be prepared with multivalent active hydrogen compounds such as di- and tri-amines and di- and tri-thiols. Individual examples are aromatic polyisocyanates containing urethane groups, preferably having NCO contents of from 5 to 40 weight percent, more preferably 20 to 35 weight percent, obtained by reaction of diisocyanates and/or polyisocyanates with, for example, lower molecular weight diols, triols, oxyalkylene glycols, dioxyalkylene glycols or polyoxyalkylene glycols having molecular weights up to about 800. These polyols can be employed individually or in mixtures as di- and/or polyoxyalkylene glycols. For example, diethylene glycols, dipropylene glycols, polyoxyethylene glycols, ethylene glycols, propylene glycols, butylene glycols, polyoxypropylene glycols and polyoxypropylenepolyoxyethylene glycols can be used. Polyester polyols can also be used as well as alkyl diols such as butane diol. Other diols also useful include bishydroxyethyl-or bishydroxypropyl-bisphenol A, cyclohexane dimethanol, and even bishydroxyethyl hydroquinone.

Useful as the polyisocyanate component of the prepolymer formulations of the present invention are: (i) polyisocyanates having an NCO content of from 8 to 40 weight percent containing carbodiimide groups and/or urethane groups, from 4,4′-diphenylmethane diisocyanate or a mixture of 4,4′- and 2,4′-diphenylmethane diisocyanates; (ii) prepolymers containing NCO groups, having an NCO content of from 2 to 35 weight percent, based on the weight of the prepolymer, prepared by the reaction of polyols, having a functionality of preferably from 1.75 to 4 and a molecular weight of from 800 to 15,000 with 4,4′-diphenylmethane diisocyanate or with a mixture of 4,4′- and 2,4′-diphenylmethane diisocyanates and mixtures of (i) and (ii); and (iii) 2,4- and 2,6-toluene-diisocyanate and the corresponding isomeric mixtures.

PMDI in any of its forms is the most preferred polyisocyanate for use with the present invention. When used, it preferably has an equivalent weight between 125 and 300, more preferably from 130 to 175, and an average functionality of greater than about 1.5. More preferred is an average functionality of from 1.75 to 3.5. The viscosity of the polyisocyanate component is preferably from 25 to 5,000 centipoise (cPs) (0.025 to about 5 Pa*s), but values from 100 to 1,000 cPs at 25 C (0.1 to 1 Pa*s) are preferred for ease of processing. Similar viscosities are preferred where alternative polyisocyanate components are selected. Still, preferably, the polyisocyanate component of the formulations of the present invention is selected from the group consisting of MDI, PMDI, an MDI prepolymer, a PMDI prepolymer, a modified MDI and mixtures thereof.

Optional additives

The polyurethane foams of the present invention are advantageously prepared using optional additives such as surfactants, catalysts, flame retardants, fillers. For example, amine catalysts can be used with the formulations of the present invention. Any organic compound containing at least one tertiary nitrogen atom and which is capable of catalyzing the hydroxyl/isocyanate reaction can be used in the present blends. Typical classes of arnines include the N-alkylmorpholines, N-alkylalkanolamines, N,N-dialkylcyclohexylamines, and alkylamines where the alkyl groups are methyl, ethyl, propyl, butyl and isomeric forms thereof, and heterocyclic amines. Typical but not limiting thereof are triethylenediamine, tetramethylethylenediamine, bis(2-dimethylaminoethyl) ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, 2,4,6-tri (dimethylaminomethyl)phenol, N,N′N″-tris(dimethylaminopropyl)-sym-hexahydrotriazine, and mixtures thereof. A preferred group of tertiary amines comprises bis(2-dimethylaminoethyl)ether, dimethylcyclohexylamine, N,N-dimethylethanolamine, triethylenediamine, triethylamine, 2,4,6-tri(dimethylaminomethyl)phenol, N,N′,N″-tris(dimethylaminopropyl)sym-hexahydrotriazine, N-ethylmorpholine, and mixtures thereof.

Non-amine catalyst can also be used with the present invention. Typical of such catalysts are organometallic compounds of bismuth, lead, tin, titanium, iron, antimony, uranium, cadmium, cobalt, thorium, aluminum, mercury, zinc, nickel, cerium, molybdenum, vanadium, copper, manganese, zirconium. Included as illustrative examples are bismuth nitrate, lead 2-ethylhexoate, lead benzoate, lead naphthenate, ferric chloride, antimony trichloride, antimony glycolate: a preferred organo-tin class includes the stannous salts of carboxylic acids such as stannous acetate, stannous octoate, stannous 2-ethylhexoate, 1-methylimidazole, stannous laurate, as well as the dialkyl tin salts of carboxylic acids such as dibutyl tin diacetate, dibutyl tin dilaurate, dibutyl tin dimaleate, dioctyl tin diacetate.

One or more trimerization catalysts can be used with the present invention. The trimerization catalyst employed can be any catalyst known to those skilled in the art which will catalyze the trimerization of an organic isocyanate compound to form the isocyanurate moiety. For typical isocyanate trimerization catalysts see The Journal of Cellular Plastics, November/December 1975, page 329: U.S. Pat. Nos. 3,745,133, 3,896,052, 3,899,443, 3,903,018, 3,954,684, and 4,101,465, the disclosures of these patent references being hereby incorporated by reference herein. Typical trimerization catalysts include the glycine salts and tertiary amine trimerization catalysts and alkali metal carboxylic acid salts and mixtures of the various types of catalysts. Preferred species within the classes are sodium N-(2-hydroxy-5-nonylphenyl)methyl-N-methylglycinate, and N,N-dimethylcyclohexylamine, and mixtures thereof. Also included in the preferred catalyst components are the epoxides disclosed in U.S. Pat. No. 3,745,133.

Other additives useful with the present invention can include one or more flame retardants such as tris(2-chloroethyl)phosphate, tris(2-chloropropyl)phosphate, tris(2,3-dibromopropyl)phosphate,tris(1,3-dichloropropyl)phosphate, diammonium phosphate, various halogenated aromatic compounds, antimony oxide, alumina trihydrate, polyvinyl chloride, and mixtures thereof to control flame retardancy. Dispersing agents, cell stabilizers, and surfactants can also be incorporated into the formulations of the present invention. Surfactants, including organic surfactants and silicone based surfactants, are added to serve as cell stabilizers. Some representative materials are sold under the names of SF-1109, L-520, L-521 and DC-193 which are, generally, polysiloxane polyoxyalkylene blocked co-polymers, such as those disclosed in U.S. Pat. Nos. 2,834,748; 2,917,480; and 2,846,458, for example. Also included are organic surfactants containing polyoxyethylene-polyoxybutylene block copolymers as described in U.S. Pat. No. 5,600,019. Other additives such as carbon black, colorants can be added. The addition of fillers such as barium sulfate may be used in the foams of the present invention.

### EXAMPLES

The following examples are provided to illustrate the present invention. The examples are not intended to limit the scope of the present invention and should not be so interpreted. Amounts are in weight parts or weight percentages unless otherwise indicated.

“Polyol A” is a Novolac polyol having an OH number of about 200, prepared from Novolac initiator and having a Novolac content of about 37 percent.

### Example 1

Example 1

| | | |
|---|---|---|
| Ratio 1:1 (Isocyanate:Polyol) by Volume Spray Foam | | |
| System | | |
| PMDI Isocyanate | 136 | pbw |
| Ultra low viscosity Mannich Polyol | 50.0 | pbw |
| Novolac Polyol A | 50.0 | pbw |
| Tris(2-chloropropyl) phosphate | 12.0 | pbw |
| Organic surfactant | 2.0 | pbw |
| Tertiary amine catalyst | 2.0 | pbw |
| Lead Napthanate catalyst | 0.1 | pbw |
| Trimerization catalyst | 2.0 | pbw |
| Water | 2.4 | pbw |
| Properties generated from spray applied foam: | | |
| Core Density, pcf 3.0 | | |
| Compressive Strength, psi 51 | | |
| k-Factor, Bru. in/ft². hr. ° F. 0.18 | | |
| Friability, % 5 | | |
| Closed Cell Content, % 96 | | |
| Tensile Strength (Cohesion), psi 64 | | |
| Dimensional stability, % Δ Volume; | | |
| −22° F./Freeze, 28 days-0.1 | | |
| 200° F./dry, 28 days-3.3 | | |
| 158° F./95% R.H., 28 days-3.5 | | |
| ASTM E 108-98 Flammability; | | |
| Burning Brandpassed | | |
| Intermittent Flamepassed | | |

Example 2

| | | |
|---|---|---|
| Pour-in-place Foam System | | |
| PMDI Isocyanate | 202.0 | pbw |
| Ultra low viscosity Mannich Polyol | 75.0 | pbw |
| Novolac Polyol A | 21.0 | pbw |
| VORANOL^{R} 225 Polyol | 4.0 | pbw |
| Organic surfactant | 2.0 | pbw |
| Silicone surfactant | 1.0 | pbw |
| Tertiary amine catalyst | 0.3 | pbw |
| Trimerization catalyst | 1.5 | pbw |
| Water | 6.5 | pbw |
| Properties Generated from Molded Foam: | | |
| Core Density, pcf 2.0 | | |
| Compressive Strength, psi 18 | | |
| k-Factor, Btu. in/ft². hr. ° F. 0.160 | | |
| Friability, % 2 | | |
| Closed Cell Content, % 93 | | |
| Dimensional stability, % Δ Volume; | | |
| −22° F./Freeze, 28 days-0.9 | | |
| 200° F./Dry, 28 days-2.6 | | |
| 158° F./95% R.H., 28 days-5.0 | | |

### Example 2

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

I claim:

1. A composition for preparing polyurethane comprising
(a) a polyisocyanate component
(b) a polyol component comprising a first polyol comprising an ultra low viscosity Mannich polyol having a viscosity less than about 3,500 cps (3.5 Pa*s) at 25° C., and a second polyol comprising a polyol that is not a low viscosity Mannich polyol.

2. The composition of claim 1, wherein the vol (wt/vol) ratio of the polyisocyanate component to polyol component is in the range of about 0.2 to about 3.5.

3. The composition of claim 1, wherein the second polyol comprises a Novalak polyol.

4. The composition of claim 2, wherein the Mannich polyol has a viscosity of from 300 to 1500 cps (0.3 to 1.5 Pa*s).

5. The composition of claim 4, wherein the Mannich polyol has a viscosity of from 300 to 1000 cps (0.3 to 1.0 Pa*s).

6. The composition of claim 4 wherein the Mannich polyol has an OH number of from about 200 to about 500.

7. The composition of claim 4 wherein the Mannich polyol has an OH number of from about 200 to about 450.

8. The composition of claim 4, wherein the vol (wt/vol) ratio of the polyisocyanate component to polyol component is in the range of about 0.2 to about 3.5.

9. The composition of claim 4 wherein water is present as a blowing agent.

10. The composition of claim 4 wherein water is present as a blowing agent at a concentration of from about 0.5 to about 25 parts per hundred parts of the polyol component.

11. The composition of claim 4 wherein water is present as a blowing agent at a concentration of from about 3 to about 20 parts per hundred parts of the polyol component.

12. The composition of claim 4 wherein water is present as a blowing agent at a concentration of from about 4 to about 10 parts per hundred parts of the polyol component.

13. A polyurethane that is the reaction product of:
(a) a polyisocyanate component; and
(b) a polyol component comprising a first polyol comprising an ultra low viscosity Mannich polyol having a viscosity less than about 3,500 cps (3.5 Pa*s) at 25° C., and a second polyol comprising a polyol that is not a low viscosity Mannich polyol.

14. The polyurethane of claim 13, wherein the vol (wt/vol) ratio of the polyisocyanate component to polyol component is in the range of about 0.2 to about 3.5.

15. The polyurethane of claim 13,wherein the second polyol comprises a Novalak polyol.

16. The polyurethane of claim 15, wherein the vol (wt/vol) ratio of the polyisocyanate component to polyol component is in the range of about 0.2 to about 3.5

17. The polyurethane of claim 15, wherein the Mannich polyol has a viscosity of from 300 to 1500 cps (0.3 to 1.5 Pa*s).

18. The polyurethane of claim 15, wherein the Mannich polyol has a viscosity of from 300 to 1000 cps (0.3 to 1.0 Pa*s).

19. The polyurethane of claim 15 wherein the Mannich polyol has an OH number of from about 200 to about 500.

20. The polyurethane of claim 15 wherein the Mannich polyol has an OH number of from about 250 to about 350.

21. The polyurethane of claim 15, wherein the vol (wt/vol) ratio of the polyisocyanate component to polyol component is in the range of about 0.2 to about 3.5

22. The polyurethane of claim 15 wherein water is utilized as a blowing agent.

23. The polyurethane of claim 15 wherein water is utilized as a blowing agent at a concentration of from about 0.5 to about 25 parts per hundred parts of the polyol component.

24. The polyurethane of claim 4 wherein water is utilized as a blowing agent at a concentration of from about 3 to about 20 parts per hundred parts of the polyol component.

25. The polyurethane of claim 4 wherein water is utilized as a blowing agent at a concentration of from about 4 to about 10 parts per hundred parts of the polyol component.

26. A polyol composition comprising
(a) a first polyol comprising an ultra low viscosity Mannich polyol having a viscosity less than about 3,500 cps (3.5 Pa*s) at 25° C.; and
(b) a second polyol comprising a polyol that is not a low viscosity Mannich polyol.

27. The composition of claim 26, wherein the second polyol comprises a Novolac polyol.

28. The composition of claim 27, wherein the Mannich polyol has a viscosity of from 300 to 1500 cps (0.3 to 1.5 Pa*s).

29. The composition of claim 27, wherein the Mannich polyol has a viscosity of from 300 to 1000 cps (0.3 to 1.0 Pa*s).

30. The composition of claim 27 wherein the Mannich polyol has an OH number of from about 200 to about 500.

31. The composition of claim 27 wherein the Mannich polyol has an OH number of from about 250 to about 350.

32. The composition of claim 27, wherein the vol (wt/vol) ratio of the polyisocyanate component to polyol component is in the range of about 0.2 to about 3.5.
